(19) United States
(12) Patent Application Publication
(10) Pub. No.: US 2024/0338643 A1
(43) Pub. Date: Oct. 10, 2024

(54) Virtual Sorting and Distribution System for Package Delivery Services

(71) Applicant: Shuang Chen, Somers, NY (US)

(72) Inventor: Shuang Chen, Somers, NY (US)

(21) Appl. No.: 18/630,373

(22) Filed: Apr. 9, 2024

Related U.S. Application Data
(60) Provisional application No. 63/495,168, filed on Apr. 10, 2023.

(51) Int. Cl. G06Q 10/0833

(52) U.S. Cl. CPC G06Q 10/0833

(57) ABSTRACT

Provided herein are electronic package delivery systems, distributed cloud computing systems, and platforms for initiating a package delivery order which utilize a virtual sorting and distribution system to receive a sender's or a customer's request for a package delivery. Also provided are user-implemented methods and computer-implemented methods to make or to receive the request as input, to reply with package delivery work plan options as output and to make and receive the acceptance of the best package delivery work plan.

### CROSS-REFERENCE TO RELATED APPLICATIONS

This non-provisional application claims benefit of priority under 35 U.S.C. § 119 (e) of provisional application U.S. Ser. No. 63/495,168, filed Apr. 10, 2023, the entirety of which is hereby incorporated by reference.

### BACKGROUND OF THE INVENTION

### Field of Invention

The present invention relates generally to the fields of distributed internet services and middleware, cloud computing services and computer models and their integration to enhance online commerce systems. More specifically, the present invention relates to computer systems, platforms, models, and methods related to fast intercity delivery of parcels or small packages in the package delivery or the courier, express and parcel (CEP) industries.

### Description of the Related Art

It's commonly recognized that the FedEx Corporation pioneered overnight package delivery services. In fact, the overnight delivery is still the fastest intercity package delivery service standard even 50 years later. Today, there are three major package delivery service companies that dominate the overnight delivery market in the United States, i.e., FedEx, UPS and USPS (United States Postal Service), with the total number of packages delivered roughly about 17 billion in 2021.

Overnight delivery is made possible by utilizing the so-called “Hub-and-Spoke” model on a large scale. A package from the sender enters the delivery system and is sorted at a local sorting center where the package is selected for either local truck delivery, if the receiver is local, or going to the cargo airplane for non-local delivery. The cargo planes carry all the non-local delivery packages from various places into a global sorting center which is usually located in the central region of the country. There the package is sorted again and moved to a corresponding cargo airplane for flying to the destination region. There the package is further sorted at the local sorting center in the destination region for distribution routing and then is loaded onto the corresponding truck for delivery. The truck carries the package and finally the package is delivered by the truck driver to the receiver.

This “Hub-and-Spoke” model relies on economies of scale. A package is usually entered into the system by a cut off time, for example, 7 pm local time. Then the multi-level sorting and air transportation are all done in the nighttime, and the package is delivered the next day, thus overnight.

This is the fastest way this model delivers a package, but it is also the limitation of this model. A package can't be delivered on the same day by this model.

The prior art is deficient in the lack of a virtual sorting and distribution networked computer system integrated with distributed internet services, fully utilizing existing intercity transportation resources available to minimize the door-to-door time of the package delivery, created a new generation of the same-day delivery with a fraction of the cost compared with existing overnight delivery. The present invention provides this longstanding need and desire in the art.

### SUMMARY OF THE INVENTION

The present invention is direct to a user-implemented method for initiating a package delivery order on an electronic device having at least a processor, a memory and a network connection. In this method, a delivery work request is inputted into an e-package delivery system on the electronic device. Delivery work plan options and corresponding delivery prices provided by the e-package delivery system are reviewed. A best delivery work plan and corresponding delivery price is accepted from among the delivery work plan options and the delivery price is paid.

The present invention is further directed to a distributed e-package delivery system for initiating a package delivery order in real time. The distributed e-package delivery system has at least one processor, at least one memory in communication with the processor; and at least one network connection from a central cloud server to an electronic device at an end-user location, said memory tangibly storing processor-executable instructions. The processor-executable instructions, when executed, are configured to receive a delivery work request from a sender, receive information related to one or more delivery work plans from all available sources, select a best delivery work plan option based on time, cost and a sender's requirements, provide in real-time the best delivery work plan and a corresponding price to the sender, confirm the delivery work plan with the sender, create the delivery work order, complete the transaction with the sender, dispatch the delivery work order to at least one mobile device of at least one assigned mobile worker, track a status of the delivery work order in real time and respond to any inquiry from the sender, and record completion of the delivery work order or enter an exception into a handling procedure.

The present invention is directed further to a distributed cloud computer system, comprising the distributed e-package delivery system described herein installed on a computer as a platform configured to initiate and process a package delivery order in real time.

The present invention is directed further still to a method for improving user experience during an electronic transaction for a package delivery. In this method, a user inquiry is received as input into an e-commerce system networked to a central cloud server comprising the distributed e-package delivery system as described herein. The inquiry is processed with an application or components thereof distributed and deployed to a local server on the distributed e-package delivery system from the central cloud server via a Distributed Internet Services system thereon and a response to the inquiry is displayed in real time to the user, thereby improving the user experience.

The present invention is directed further still to computer-implemented method for initiating a package delivery order. In this computer-implemented method, a user inquiry about delivering a package is receiver as input into a virtual sorting and distribution delivery system on an electronic device networked to a central cloud server comprising a distributed cloud computer system. The input is processed by distributing an application or components thereof located in the central cloud server to a target on a selected client tier on the virtual sorting and distribution delivery system. A response to the user inquiry comprising at least one delivery work plan and a corresponding delivery price is displayed in real time and the user's selection of the delivery work plan and corresponding delivery price is selected.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages, and objects of the invention, as well as others which will become clear, are attained, and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1 shows the Virtual Sorting and Distribution (VSD) System 100 platform which has seven subsystems 110 to 170.

FIG. 2 is the functional flowchart of how the Virtual Sorting and Distribution system conducts the virtual sorting and distribution functions.

### DETAILED DESCRIPTION OF THE INVENTION

As used herein, the term “a” or “an” when used in conjunction with the term “comprising” in the claims and/or the specification may mean “one,” but it is also consistent with the meaning of “one or more,” “at least one,” and “one or more than one.” Some embodiments of the invention may consist of or consist essentially of one or more elements, method steps, and/or methods of the invention. It is contemplated that any system and method described herein can be implemented with respect to any other system and method described herein.

As used herein, the term “or” in the claims is used to mean “and/or” unless explicitly indicated to refer to alternatives only or the alternatives are mutually exclusive, although the disclosure supports a definition that refers to only alternatives and “and/or.”

As used herein, the term “computer” generally includes: a processor, a memory, at least one information storage/retrieval apparatus such as, for example, a hard drive, a disk drive or a flash drive or memory stick, or other non-transitory computer readable media or non-transitory storage device, as is known in the art, at least one input apparatus such as, for example, a keyboard, a mouse, a point and touch device, a touch screen, or a microphone; and a display structure, such as a computer screen as is well-known in the art. Additionally, the computer may include one or more network connections, such as wired or wireless connections. Such a computer or computer system may include more or less than what is listed above and encompass other electronic media or electronic devices, as is known in the art, for example, but not limited to tablet computers or smart devices.

As used herein, the term “cloud” or “cloud computing” refers to a centralized and virtualized computing facility in which all the computing resources are shared there. One can no longer point to a specific machine for an application system or sub-system because they are all in the “cloud”.

As used herein, the term “Distributed Internet Services system” refers to a distributed Internet service platform that transforms Internet applications to perform in various computing environments. A Distributed Internet Services system distributes Internet applications, including content, data, and logic, to whatever extent appropriate and to any number and any kind of device across the network, via a Component Distribution Server/Asset Distribution Server. Through Distributed Internet Services, Internet applications can be hosted and managed centrally, with services based on each user's need, and cached and executed locally at the user device or nearby locations while maintaining its integrity. Any web-enabled computing device can be upgraded with the Distributed Internet Services software to become Distributed Internet Services-enabled to enjoy and perform distributed Internet services. The Distributed Internet Services system is completely described in any one of a family of patents of U.S. Pat. Nos. 7,136,857, 7,150,015, 7,181,731, 7,209,921, 7,430,610, 7,685,183, 7,685,577, 7,752,214, 8,326,883, 8,386,525, 8,443,035, 8,458,142, 8,458,222, 8,473,468, 8,527,545, and 8,650,226 and U.S. Patent Publication Nos. 20120005205 and 20130091252, all of which are commonly owned by OP40, Holdings, Inc. with the major inventor the same as the instant invention and all of which are hereby incorporated by reference.

As used herein, the terms “e-package delivery system” and “electronic package delivery system” are interchangeable and refer to a virtual sorting and distribution system that comprises a computer system, such as a distributed cloud computer system, algorithms, distributed internet services (DIS) system enabled mobile software applications for the last-mile mobile workers, and the real-time data communication with the scheduling system of various existing intercity cargo transportation resources.

In one embodiment of the present invention, there is provided a user-implemented method for initiating a package delivery order on an electronic device having at least a processor, a memory and a network connection, comprising the steps of a) inputting a delivery work request into an e-package delivery system on the electronic device; b) reviewing delivery work plan options and corresponding delivery prices provided by the e-package delivery system; c) accepting a best delivery work plan and corresponding delivery price from among the delivery work plan options; and d) paying the delivery price.

Further to this embodiment the method comprises after step b) inputting at least one request to alter a delivery work plan option. Further to both of these embodiments the method comprises tracking a status of the delivery work order. Further to both embodiments, the method comprises requesting an exception to a handling procedure for the delivery work order. In addition to these further embodiments, the method comprises repeating steps a) to d). In all embodiments, the delivery work order may be for an intercity delivery.

In another embodiment of the present invention, there is provided a distributed e-package delivery system for initiating a package delivery order in real time, comprising at least one processor; at least one memory in communication with the processor; and at least one network connection from a central cloud server to an electronic device at an end-user location, said memory tangibly storing instructions, which when executed by the processor are configured to a) receive a delivery work request from a sender; b) receive information related to one or more delivery work plans from all available sources, c) select a best delivery work plan option based on time, cost and a sender's requirements, d) provide in real-time the best delivery work plan and a corresponding price to the sender, e) confirm the delivery work plan with the sender, f) create the delivery work order, g) complete the transaction with the sender, h) dispatch the delivery work order to at least one mobile device of at least one assigned mobile worker, i) track a status of the delivery work order in real time and respond to any inquiry from the sender, and j) record completion of the delivery work order or enter an exception into a handling procedure.

Further to this embodiment, the method comprises further processor executable instructions to interface with an Intercity Transportation Resource Management System that has at least one processor, a memory, and a network connection that is configured to k) query in real time all the options of available intercity transportation schedules and capacities, l) select the desired intercity transportation schedule and capacity, and m) confirm the selection. Further to both of these embodiments, the method comprises further processor executable instructions to manage in real time operation of mobile workers at local cities or regions; receive delivery work plan options for picking up the package from the sender and delivery to the receiver; and confirm availability and time of the mobile workers or alternative options thereof. Further to both embodiments, the method comprises further processor executable instructions to create one or more records of the transaction. In all embodiments, the one or more records may be of a sender's orders, of a sender's payments, of a sender's confirmation messages, or of terms and conditions of the package delivery order.

In yet another embodiment of the present invention, there is provided a distributed cloud computer system, comprising the distributed e-package delivery system as described supra installed on a computer as a platform configured to initiate and process a package delivery order in real time.

In this embodiment, the distributed e-package delivery system is a virtual sorting and distribution system comprising a virtual sorting and distribution system engine with direct electronic connections to a website and mobile app for customer services; a distributed internet services (DIS) system; a transaction support system; an Intercity Transportation Resource Management System; and a management system for local mobile workers. In this embodiment, the DIS system may be directly electronically connected to the website and mobile app for customer services; the management system for local mobile workers; and the mobile app for mobile workers which is directly electronically connected to the management system for local mobile workers.

In yet another embodiment of the present invention, there is provided a method for improving user experience during an electronic transaction for a package delivery, comprising the steps of receiving a user inquiry as input into an e-commerce system networked to a central cloud server comprising the distributed e-package delivery system as described supra; processing the inquiry with an application or components thereof distributed and deployed to a local server on the distributed e-package delivery system from the central cloud server via a Distributed Internet Services system thereon; and displaying, in real time, a response to the inquiry to the user, thereby improving the user experience. In this embodiment, the response may comprise a real time offer of package delivery work plan options and corresponding fees.

In yet another embodiment of the present invention, there is provided a computer-implemented method for initiating a package delivery order, comprising receiving a user inquiry about delivering a package as input into a virtual sorting and distribution delivery system on an electronic device networked to a central cloud server comprising a distributed cloud computer system; processing the input by distributing an application or components thereof located in the central cloud server to a target on a selected client tier on the virtual sorting and distribution delivery system; displaying in real time a response to the user inquiry comprising at least one delivery work plan and a corresponding delivery price; and accepting the user's selection of the delivery work plan and corresponding delivery price.

In this embodiment, the processing step may comprise deploying the distributed application or components thereof at the target on the client tier; synchronizing data on the client tier with the central cloud server; and executing the application or components deployed to the client tier. In this embodiment, the displaying step may comprise processing the input with the deployed application or components thereof at the target to produce an output; and transmitting the output over the network connection to a display. In addition, the client tier may be a website and mobile app for customer services or a mobile app for mobile workers or a combination thereof.

Provided herein is a Virtual Sorting-Distribution (VSD) System that utilizes a computing platform that enables in real time same day scheduling, pick-up, transportation, and delivery of packages, for example, letter size packages and small and larger size packages, via multi-modal intercity transportation capacities, such as, but not limited to, via mobile workers, trains, airlines, passenger coach buses with dedicated cargo spaces, freight trucks, and metro transportation systems. The Virtual Sorting-Distribution system offers the same day intercity express delivery by eliminating the hub-and-spoke model in today's industry by minimizing the delivery cost by bulk purchasing and eventually bartering with intercity passenger transportation operators for their daily unused cargo capacities. Utilizing the Virtual Sorting-Distribution computing platform provided herein minimizes the time and cost of every package delivery. The Virtual Sorting-Distribution system with smart cloud services helps the intercity passenger transportation operators by providing the most convenient door-to-door trip planning, the most usable time and comfortable experience for passengers and big data service for the operators, thus raising significant ridership for the operators in exchange to lock-in the barter for unused cargo spaces.

Embodiments of the present invention are better illustrated with reference to the Figure(s), however, such reference is not meant to limit the present invention in any fashion. The embodiments and variations described in detail herein are to be interpreted by the appended claims and equivalents thereof.

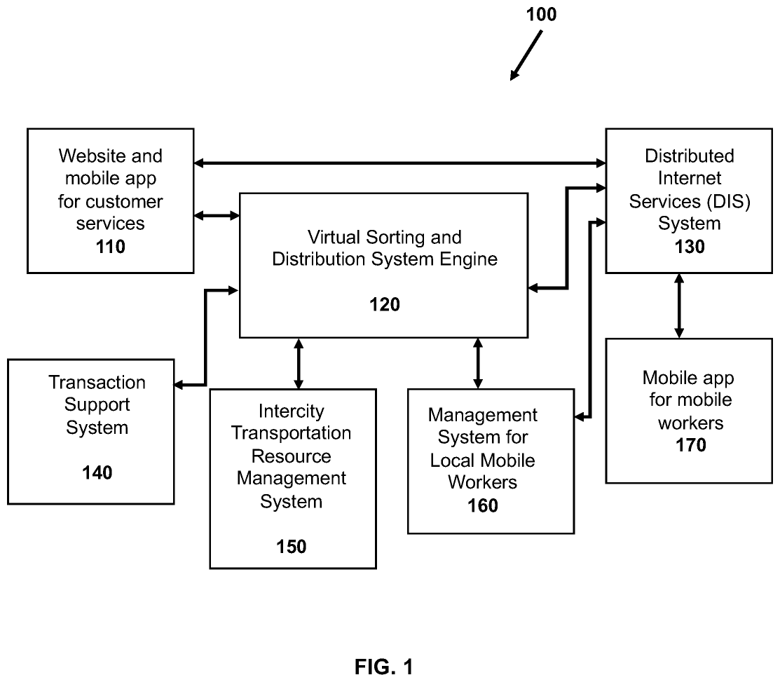

FIG. 1 illustrates the Virtual Sorting and Distribution System 100 which has seven subsystems in electronic communication. A Website and mobile app for customer services 110 is in electronic communication with the Virtual Sorting and the Distribution System Engine 120 and with the Distributed Internet Services (DIS) System 130. The Virtual Sorting-Distribution engine is in electronic communication with the DIS System, with the Transaction Support System 140, with the Intercity Transportation Resource Management System 150, and with the Management system for local mobile workers 160. The Distributed Internet Services System is in electronic communication with the Management system for local mobile workers and with the Mobile app for mobile workers 170. The Virtual Sorting-Distribution provides a platform for user-friendly, fast intercity delivery of packages and parcels.

In a general scenario, the Virtual Sorting and Distribution System 100 handles every delivery as follows:
a. The Virtual Sorting and Distribution engine 120 receives the delivery work request from the sender via user interfaces in the website or mobile app for customer services 110,
b. The Virtual Sorting and Distribution engine receives information related to one or more delivery work plans from all available sources, i.e., the Intercity Transportation Resource Management System 150, Management system for local mobile workers 160 and Mobile app for mobile workers 170,
c. The Virtual Sorting and Distribution engine selects the best delivery work plan options based on time, cost and given sender's requirement,
d. The Virtual Sorting and Distribution engine provides in real-time the best delivery work plan and the corresponding price quote to the sender's website or mobile app 110,
e. The Virtual Sorting and Distribution engine confirms the delivery work plan with the sender, creates the delivery work order, completes the transaction, such as, but not limited to, creating a customer order record, processing payment, customer confirmation messages, terms and conditions, etc., with the sender at 110 and the Transaction Support System 140,
f. The Virtual Sorting and Distribution engine dispatches the delivery work order to the mobile devices of the assigned mobile workers via the Distributed Internet Services system 130 and the Mobile app for mobile workers 170,
g. The Virtual Sorting and Distribution engine tracks the real-time delivery work order status and responds to sender's inquiry via the Management system for local mobile workers 160 and the Mobile app for mobile workers,
h. The Virtual Sorting and Distribution engine records the completion of the delivery work order or enter into exception a handling procedure via the Management system for local mobile workers, and
i. The Virtual Sorting and Distribution engine completes the delivery work order.

The Virtual Sorting and Distribution System 100 handles the mobile workers that conduct package delivery and pickup as follows:
a. The Virtual Sorting and Distribution engine 120 receives delivery work plan options for picking up the package from the sender and delivery to the receiver via the Management system for local mobile workers 160,
b. The Virtual Sorting and Distribution engine confirms the local mobile workers' availability and time or with alternative options via the Management system for local mobile workers, and
c. The Virtual Sorting and Distribution engine replies to the customer on the website or mobile app at 110 with the confirmed plan to the requested options with the corresponding conditions such as the confirmation is valid only within certain time period.

The Virtual Sorting and Distribution System 100 handles the availabilities of the intercity transportation resources in the following steps:
a. The Virtual Sorting and Distribution engine 120 queries in real-time all the options of available intercity transportation schedules and capacities via the Intercity Transportation Resource Management system 150,
b. The Virtual Sorting and Distribution engine selects the desired intercity transportation schedule and capacity at 150; and
c. The Virtual Sorting and Distribution engine confirms with the selection at 150.

The system utilizes the Distributed Internet Services system 130 with the following steps:
a. The Virtual Sorting and Distribution engine 120 receives an input over the network connection and, via a Distributed Internet Services system 130.
b. The DIS system 130 distributes an application or components thereof configured to process the input that is in a central cloud server to a target on a selected client tier at 170 and/or 160,
c. The DIS system 130 deploys the distributed application or components thereof at the target 110 and/or 170, and
d. The DIS system 130 synchronizes any data on the client tier at 110 and 170 with the central server 160.

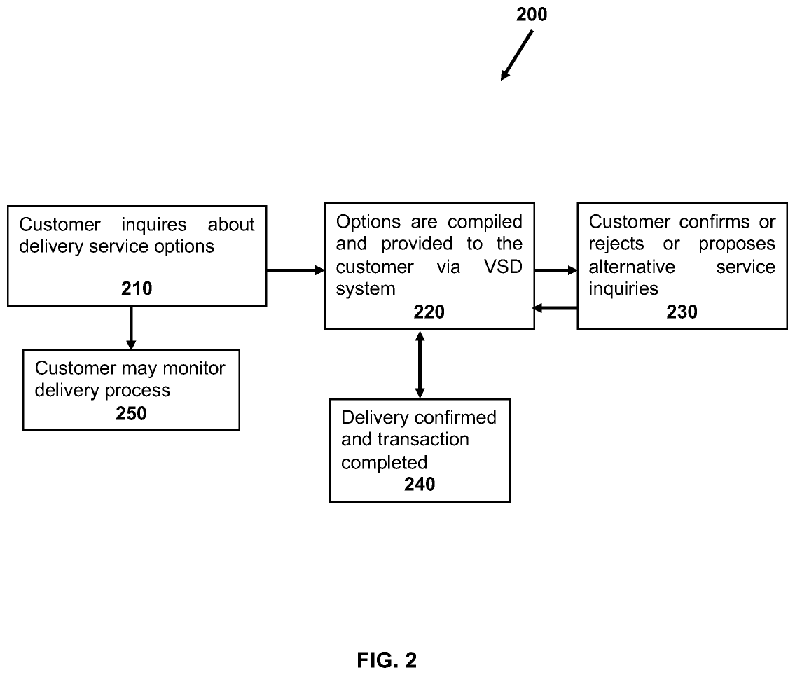

With continued reference to FIG. 1, FIG. 2 is a flowchart illustrating the package delivery method or process 200. At 210 the Customer inquires about a package delivery service providing at least the desired time, location for pick-up and delivery, and package size from the customer service applications either in the mobile app or website 110. At 220 the Virtual Sorting and Distribution engine 120 compiles options for the delivery work plan to the customer with the corresponding price quotes. At 230 the customer confirms or rejects or proposes alternative service inquiries, such as changing to another pick-up time or delivery time with the Virtual Sorting and Distribution system engine. The Virtual Sorting and Distribution engine at 240 confirms the delivery work plan with the customer and completes the transaction with the customer. The customer may continue to monitor, from the customer service application on the mobile app or on the website 110 at 250, the package delivery process for real-time updates until it is delivered or to monitor whether any concerns, if any, are resolved.

What is claimed is:

1. A user-implemented method for initiating a package delivery order on an electronic device having at least a processor, a memory and a network connection, comprising the steps of:
a) inputting a delivery work request into an e-package delivery system on the electronic device;
b) reviewing delivery work plan options and corresponding delivery prices provided by the e-package delivery system;
c) accepting a best delivery work plan and corresponding delivery price from among the delivery work plan options; and
d) paying the delivery price.

2. The user-implemented method of claim 1, further comprising after step b) inputting at least one request to alter a delivery work plan option.

3. The user-implemented method of claim 2, further comprising:
tracking a status of the delivery work order.

4. The user-implemented method of claim 2, further comprising:
requesting an exception to a handling procedure for the delivery work order.

5. The user-implemented method of claim 2, further comprising repeating steps a) to d).

6. The user-implemented method of claim 1, wherein the delivery work order is for an intercity delivery.

7. A distributed e-package delivery system for initiating a package delivery order in real time, comprising:
at least one processor;
at least one memory in communication with the processor; and
at least one network connection from a central cloud server to an electronic device at an end-user location, said memory tangibly storing instructions, which when executed by the processor are configured to:
a) receive a delivery work request from a sender;
b) receive information related to one or more delivery work plans from all available sources,
c) select a best delivery work plan option based on time, cost and a sender's requirements,
d) provide in real-time the best delivery work plan and a corresponding price to the sender,
e) confirm the delivery work plan with the sender,
f) create the delivery work order,
g) complete the transaction with the sender,
h) dispatch the delivery work order to at least one mobile device of at least one assigned mobile worker,
i) track a status of the delivery work order in real time and respond to any inquiry from the sender, and
j) record completion of the delivery work order or enter an exception into a handling procedure.

8. The distributed e-package delivery system of claim 7, comprising further processor executable instructions to:
interface with an Intercity Transportation Resource Management System that has at least one processor, a memory, and a network connection that is configured to:
k) query in real time all the options of available intercity transportation schedules and capacities,
l) select the desired intercity transportation schedule and capacity, and
m) confirm the selection.

9. The distributed e-package delivery system of claim 8, comprising further processor executable instructions to:
manage in real time operation of mobile workers at local cities or regions;
receive delivery work plan options for picking up the package from the sender and delivery to the receiver; and
confirm availability and time of the mobile workers or alternative options thereof.

10. The distributed e-package delivery system of claim 7, comprising further processor executable instructions to:
create one or more records of the transaction.

11. The distributed e-package delivery system of claim 7, wherein the one or more records are of a sender's orders, of a sender's payments, of a sender's confirmation messages, or of terms and conditions of the package delivery order.

12. A distributed cloud computer system, comprising the distributed e-package delivery system of claim 7 installed on a computer as a platform configured to initiate and process a package delivery order in real time.

13. The distributed cloud computer system of claim 12, wherein the distributed e-package delivery system is a virtual sorting and distribution system comprising a virtual sorting and distribution system engine with direct electronic connections to:
a website and mobile app for customer services;
a distributed internet services (DIS) system;
a transaction support system;
an Intercity Transportation Resource Management System; and
a management system for local mobile workers.

14. The distributed cloud computer system of claim 13, wherein the DIS system is directly electronically connected to:
the website and mobile app for customer services;
the management system for local mobile workers; and
the mobile app for mobile workers which is directly electronically connected to the management system for local mobile workers.

15. A method for improving user experience during an electronic transaction for a package delivery, comprising the steps of:
receiving a user inquiry as input into an e-commerce system networked to a central cloud server comprising the distributed e-package delivery system of claim 7;
processing the inquiry with an application or components thereof distributed and deployed to a local server on the distributed e-package delivery system from the central cloud server via a Distributed Internet Services system thereon; and
displaying, in real time, a response to the inquiry to the user, thereby improving the user experience.

16. The method of claim 14, wherein the response comprises a real time offer of package delivery work plan options and corresponding fees.

17. A computer-implemented method for initiating a package delivery order, comprising:
receiving a user inquiry about delivering a package as input into a virtual sorting and distribution delivery system on an electronic device networked to a central cloud server comprising a distributed cloud computer system;
processing the input by distributing an application or components thereof located in the central cloud server to a target on a selected client tier on the virtual sorting and distribution delivery system;
displaying in real time a response to the user inquiry comprising at least one delivery work plan and a corresponding delivery price; and
accepting the user's selection of the delivery work plan and corresponding delivery price.

18. The computer-implemented method of claim 17, wherein the processing step comprises:
deploying the distributed application or components thereof at the target on the client tier;
synchronizing data on the client tier with the central cloud server; and
executing the application or components deployed to the client tier.

19. The computer-implemented method of claim 18, wherein the displaying step comprises:
processing the input with the deployed application or components thereof at the target to produce an output; and
transmitting the output over the network connection to a display.

20. The computer-implemented method of claim 16, wherein the client tier is a website and mobile app for customer services or a mobile app for mobile workers or a combination thereof.
